(19) United States
(12) Patent Application Publication
(10) Pub. No.: US 2012/0117740 A1
(43) Pub. Date: May 17, 2012

(54) Medical Suction Clearing Apparatus

(75) Inventors: Mark Berry, Rancho Santa Margarita, CA (US); Kenneth D. Lewis, Rancho Santa Margarita, CA (US)

(73) Assignee: ONTIUM, LLC

(21) Appl. No.: 12/948,642

(22) Filed: Nov. 17, 2010

(51) Int. Cl. B08B 9/00

(52) U.S. Cl. 15/104.05

(57) ABSTRACT

A suction cleaning apparatus is a generally cylindrical vessel for enclosing any suitable cleaning fluid such as water or saline solution. A generally planar cleaning plate with an upper and lower surface is supported a suitable distance from the cup floor by a plurality of legs forming a fluid plenum between the lower surface of the cleaning plate and the cup floor. The upper surface of the cleaning plated has a plurality of bristles extending from the upper surface for mechanically cleaning an obstructed suction tool. In use, an obstructed suction tool is inserted into the cleaning fluid and pushed into engaging the bristles. The bristles are sized such that one bristle extends into the obstructed suction tool to mechanically disengage the obstruction. The bristles may include a central channel for conducting cleaning fluid from the fluid plenum to the tip of the bristle increasing fluid flow into and obstructed suction tool to expedite clearing the obstruction. The cleaning plate may also be perforated to increase fluid flow around the tip of an obstructed suction tool when it is engaging the bristles.

### FIELD OF THE INVENTIONS

The inventions described below relate to the field of surgical tools and more specifically to surgical tools for clearing obstructions in surgical suction devices.

### BACKGROUND OF THE INVENTIONS

Surgical procedures are complicated, dangerous and expensive. The tools used by surgeons are selected to provide the greatest utility and efficiency to achieve optimal outcomes for the patient. A basic tool used in virtually every surgical procedure is suction which is implemented through a slender tube. During surgery, the suction tube may become clogged with tissue being removed from the surgical site. Once clogged, the suction apparatus requires a surgical assistant to clear the obstruction to enable the surgery to continue. With surgery costs into the hundreds of dollars per minute, every minute wasted is expensive and potentially dangerous for the patient.

### SUMMARY

A suction cleaning apparatus as described below is a generally cylindrical vessel for enclosing any suitable cleaning fluid such as water or saline solution. A generally planar cleaning plate with an upper and lower surface is supported a suitable distance from the cup floor by a plurality of legs forming a fluid plenum between the lower surface of the cleaning plate and the cup floor. The upper surface of the cleaning plated has a plurality of bristles extending from the upper surface for mechanically cleaning an obstructed suction tool. In use, an obstructed suction tool is inserted into the cleaning fluid and pushed into engaging the bristles. The bristles are sized such that one bristle extends into the obstructed suction tool to mechanically disengage the obstruction. The bristles may include a central channel for conducting cleaning fluid from the fluid plenum to the tip of the bristle increasing fluid flow into and obstructed suction tool to expedite clearing the obstruction. The cleaning plate may also be perforated to increase fluid flow around the tip of an obstructed suction tool when it is engaging the bristles.

The devices and methods described below provide for a cleaning apparatus to be provided for every procedure requiring suction to enable a surgeon to quickly clear an obstructed suction tool without surrendering the suction tool. A suction cleaning cup is an open top vessel containing clean saline or other suitable cleaning liquid. The cleaning cup includes generally planar cleaning plate that is spaced above the floor of the cup to create a fluid filled plenum between the cleaning plate and the floor of the cleaning cup. The cleaning plate is perforated to permit fluid flow from the plenum through the cleaning plate into a suction tool to prevent loss of suction while clearing an obstruction of the suction tool bore. The upper surface of the cleaning plate includes one or more areas with arrays of tapered cleaning bristles sized to extend inside the suction tool bore to mechanically clear the suction tool bore.

The tapered bristles are configured with a central channel to conduce fluid from the fluid plenum to the tip of the bristle. The tapered bristles also include longitudinal flutes which improve fluid flow between generally parallel vertex ridges. The improved fluid flow through the flutes helps clear obstructed suction tools.

The bristles may be arranged by height on the cleaning plate to form areas that will be readily identifiable to a medical professional seeking to clear an obstructed suction tool. For example, on a round cleaning plate the bristles may be arranged in concentric circles forming a bulls eye pattern enabling a user to readily identify suitable areas for clearing an obstructed suction tool.

### BRIEF DESCRIPTION OF THE DRAWINGS

FIG. 1 is a perspective view of a suction cleaner cup.

FIG. 2 is a cross-section view of the cleaner cup of FIG. 1 taken along A-A.

FIG. 3 is a top view of the cleaner cup of FIG. 1.

FIG. 4 is an enlarged cross-section view of the area of the cleaner cup of FIG. 2 taken along B-B.

FIG. 5 is a side view of a cleaner bristle engaging a suction tip.

FIG. 6 is a cross section view of a cleaner bristle.

FIG. 7 is a cross section view of an alternate cleaner bristle.

FIG. 8 is a cross section view of another alternate cleaner bristle.

FIG. 9 is a cross section view of another alternate cleaner bristle.

FIG. 10 is a perspective view of an alternate cleaning cup with an alternate cleaning plate.

FIG. 11 is a cross-section of the cleaning cup and cleaning plate of FIG. 10.

### DETAILED DESCRIPTION OF THE INVENTIONS

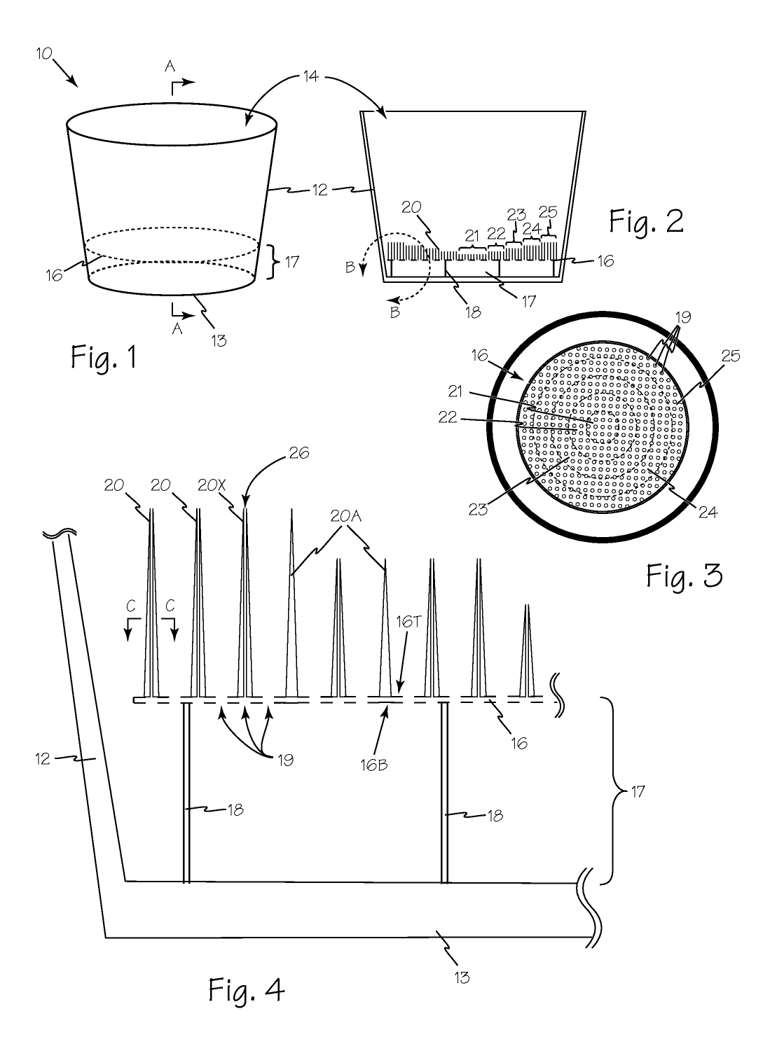

Suction cleaning cup 10 is illustrated in FIG. 1. Side wall such as wall 12 along with floor 13 define cleaning fluid volume 14. Cleaning cups such as cleaning cup 10 may adopt any suitable shape such as conical or frusto-conical to optimize the ratio of material to form the cup versus cleaning fluid volume. Cleaning plate 16 is located within cleaning fluid volume 14 and is oriented to form plenum 17 between cleaning plate 16 and cleaning cup floor 13.

Referring now to FIGS. 2, 3 and 4, cleaning plate 16 may be solid or perforated to permit fluid flow through the cleaning plate to prevent loss of suction and maintain fluid flow as a suction tool tip approaches the cleaning plate or engages the suction plate during cleaning. Plenum 17 is formed when cleaning plate 16 is maintained a suitable distance from floor 13 by one or more support legs such as support legs 18 and includes a suitable number of openings or perforations such as holes 19. A suitable number of tapered bristles such as bristles 20 are arranged in any suitable arrangement on upper surface 16T. Tapered cleaning bristles may have any suitable length and may be arranged according to length as shown or in any other suitable arrangement. In the illustrated bristle arrangement, bristles 20 are grouped and arranged according to length in a concentric arrangement similar to a target or bullseye. The shortest bristles are located in central portion 21. Intermediate length bristles are grouped and arranged in concentric portions surrounding central portion 21 such as first concentric portion 22, second concentric portion 23 and third concentric portion 24. The longest bristles are located in outer portion 25.

Tapered cleaning bristles 20 may be solid such as bristles 20A, or they may have a central tube, channel or lumen extending through cleaning plate 16 such as channel 26 of hollow bristle 20X. A cleaning plate may have a combination of solid and hollow cleaning bristles. Bristles 20 may have any suitable cross sectional shape from circular to polygonal. Bristles 20 may be formed together with cleaning plate 16 or they may be formed separately and joined together using any suitable technique.

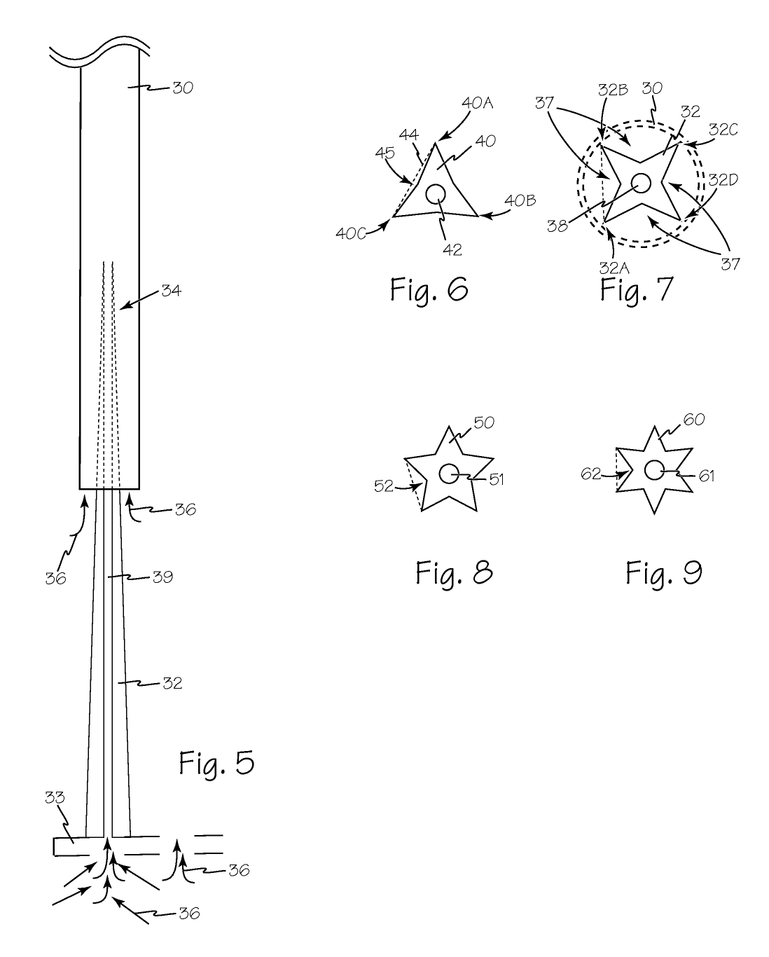

Referring now to FIGS. 5 and 7. In use, suction cleaning cup 10 is provided in surgery with a volume of cleaning liquid in cleaning fluid volume 14. When a surgical suction tube becomes clogged during surgery, a surgeon or other user may push the distal end 30D of clogged surgical suction tube 30 into cleaning fluid volume 14 and against one or more bristles such as bristle 32 formed or mounted on cleaning plate 33. A portion of a bristle such as proximal portion 34 of bristle 32 will enter suction tube 30. If the material that was clogging suction tube 30 is mechanically engaged, the clog will be cleared. Cleaning fluid 36 is also be drawn up into suction tube 30 through cleaning plate 33, through the cleaning flutes of the bristle such as cleaning flutes 37, and through channel 39.

Referring now to FIG. 6, bristle 40 is shown in cross section. Bristle 40 has three sides separated by vertices or ridges and includes central channel 42. Bristles may have any suitable number of vertices. Bristle 40 has three vertices, vertex 40A, 40B and 40C and bristle 32 of FIG. 7 has four vertices, vertices 32A, 32B, 32C and 32D. An imaginary straight line drawn between adjacent vertices such as line 44 emphasizes a flute created in one or more sides of a bristle such as flute 45 to increase fluid flow along a bristle engaged in a suction tube.

Referring now to FIG. 8, five vertex bristle 50 is shown with central channel 51 and five flutes such as flute 52.

Referring now to FIG. 9, six vertex bristle 60 is shown with central channel 61 and six flutes such as flute 62. Bristles may have any suitable number of vertices and may or may not be fluted.

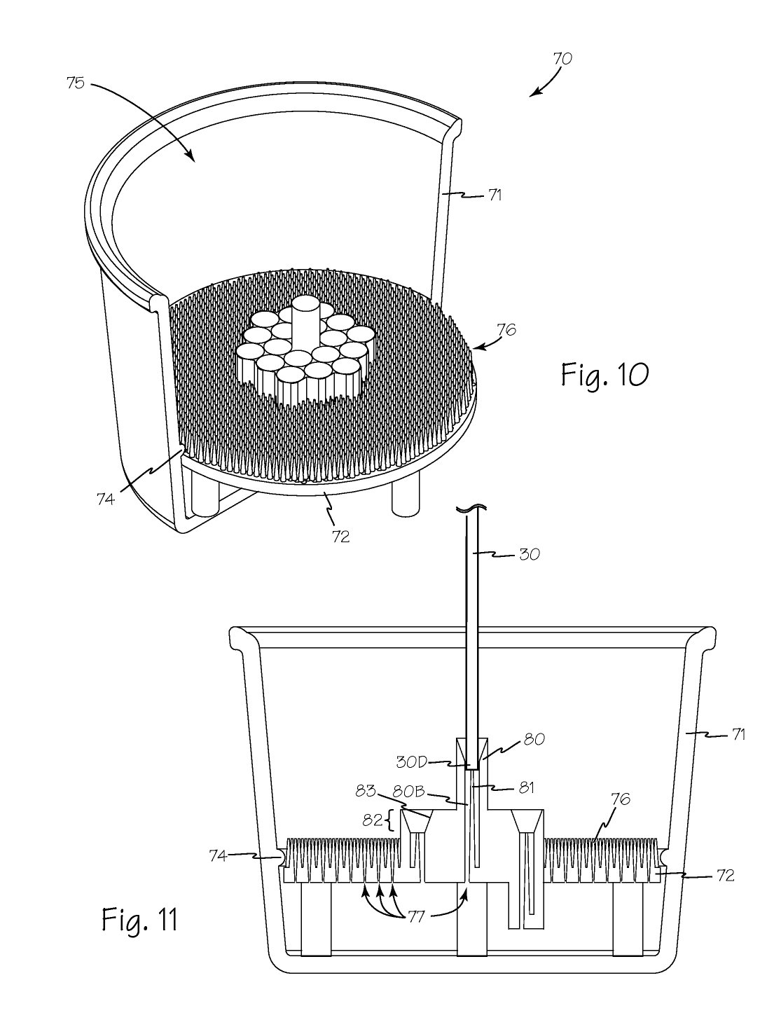

Referring now to FIGS. 10 and 11, suction cleaning system 70 includes cleaning cup 71 and cleaning plate 72. Cleaning cup 71 includes locking ring 74 which may be a ridge, bump or other suitably sized and shaped protrusion extending from inner surface 71 into cleaning fluid volume 75 to secure cleaning plate 72 in cup 71.

As discussed above, cleaning plate 72 includes a plurality of cleaning bristles such as bristles 76 and one or more openings such as fluid passages 77 for conducting any suitable cleaning fluid from plenum 78 through the cleaning plate. Cleaning plate 72 also includes one or more cleaning cylinders such as cleaning cylinder 80. The cleaning cylinders may adopt any suitable length to accommodate a suitable cleaning bristle such as bristle 81. Upper portion 82 of each cleaning cylinder may have a generally conical or funnel shape forming guide section 83 to direct distal end 30D of a suction tube into alignment with bristle 81. Bristles such as bristle 81 may adopt any suitable cross-section and may include a fluid passage such as discussed above. With cleaning cylinders to control and direct a suction tube into alignment with a single bristle, bristles such as bristle 81 may be significantly longer than bristles 76. Each cleaning cylinder may also include a fluid passage such as passage 77 to conduct cleaning fluid into bore 80B of the cleaning cylinder.

Cleaning cylinders such as cleaning cylinder 80 may be formed together with cleaning plate 72 or they may be formed separately and secured together using any suitable technique.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A suction cleaning apparatus comprising:
a generally cylindrical cleaning cup having a floor and a side wall enclosing a cleaning fluid volume;
a general planar cleaning plate having an upper surface and a lower surface;
a plurality of legs supporting the cleaning plate within the cleaning fluid volume forming a fluid plenum between the cleaning plate and the floor; and
a plurality of tapered bristles formed on the upper surface of the cleaning plate.

2. The suction cleaning apparatus of claim 1 wherein the cleaning plate is perforated.

3. the suction cleaning apparatus of claim 1 wherein one or more of the tapered bristles have central channels extending through the lower surface of the cleaning plate in fluid communication with the fluid plenum.

4. The suction cleaning apparatus of claim 1 wherein one or more of the tapered bristles has a cross section with three or more vertices.

5. The suction cleaning apparatus of claim 1 wherein one or more of the tapered bristles has a cross section with three or more vertices defining a side between each pair of adjacent vertices, and the side between each vertex is fluted.

6. The suction cleaning apparatus of claim 1 further comprising:
one or more cleaning cylinders formed on the upper surface of the cleaning plate.

7. An improved suction cleaning apparatus comprising a cleaning fluid cup with a side wall and floor enclosing a cleaning fluid volume and a plurality of bristles wherein the improvement comprises:
a general planar cleaning plate having an upper surface and a lower surface and a plurality of perforations extending from the upper surface through the lower surface;
a plurality of legs supporting the cleaning plate within the cleaning fluid volume forming a fluid plenum between the cleaning plate and the floor; and
wherein the plurality of tapered bristles are formed on the upper surface of the cleaning plate.

8. The improved suction cleaning apparatus of claim 7 wherein the tapered bristles have central channels extending through the lower surface of the cleaning plate in fluid communication with the fluid plenum and a cross section with three or more vertices defining a side between adjacent pairs of vertices and the side between each vertex is fluted.
